(19) United States
(12) Patent Application Publication
(10) Pub. No.: US 2016/0063188 A1
(43) Pub. Date: Mar. 3, 2016

(54) ANIMAL DATA MANAGEMENT SYSTEM AND METHODS OF MANAGING ANIMAL DATA

(71) Applicants: Brandon Thornberry, Kirkwood, MO (US); Nicholas Harrison, Columbia, MO (US)

(72) Inventors: Brandon Thornberry, Kirkwood, MO (US); Nicholas Harrison, Columbia, MO (US)

(21) Appl. No.: 14/838,984

(22) Filed: Aug. 28, 2015

Related U.S. Application Data
(60) Provisional application No. 62/043,747, filed on Aug. 29, 2014.

(51) Int. Cl. G06F 19/00; H04L 29/06

(52) U.S. Cl. CPC G06F 19/322; H04L 63/08

(57) ABSTRACT

A computer implemented method for managing animal information between a remote server and an animal device is provided. The method includes storing the animal information on an animal database of the remote server; receiving, by the remote server, an authentication request of an identity parameter that is associated with the animal device; authenticating, by the remote server, the authentication request; and transmitting, by the remote server, the animal information from the animal database to a computing device.

### CROSS-REFERENCE TO RELATED APPLICATION

This non provisional application claims priority to U.S. Provisional Patent Application Ser. No. 62/043,747, filed on Aug. 29, 2014, which is hereby incorporated by reference in its entirety.

### BACKGROUND

The embodiments described herein relate to a data management system, and more particularly, to data management systems and methods for storing, managing, and transmitting information relating to medical records for human patients or animals.

Health records for animals are usually maintained by an animal's veterinarian/health clinic describing the medical history of the animal, immunization records, and the like. Moreover, breeding animals and show animals require different kinds of certificates and documents showing information such as, for example, genealogy lineage. Accordingly, pets and other animals require some paperwork, which typically is kept at the veterinary or animal health clinic or kept in the owner's home.

For medical issues, some pet owners may seek and/or act on un-validated health advice provided over the Internet rather than consulting a veterinarian. Consequently, some veterinarians may be practicing at reduced capacity such as, for example, practicing at 70% capacity. Moreover, pet health records may be isolated to a certain veterinary hospital and may not be universally or immediately available to all veterinarians and pet owners in emergency situations.

Some general companion animal veterinary practices no longer see after-hours emergencies and instead defer their after-hour emergencies to local and regional 24/7 emergency veterinary hospitals. A significant number of pet owners may now be taking their pet to a novel location away from their normal veterinary hospital during a time of emergency. However, the pet owner's regular veterinary hospital still retains the medical records of their pet over its lifetime and current technology does not effectively allow these medical records to travel with the pet to the regional 24/7 hospital as efficiently as they should during times of emergency. Emergency veterinarians within these regional 24/7 hospitals can wait hours and potentially days to have access to the pet's medical history that is held within the primary veterinarian's hospital. The initial hours and days of an emergency are critical and impact a veterinarian's course of treatment significantly, which greatly influences the outcome of the pet's recovery.

For the pet emergency marketplace, numerous pet owners and veterinarians are in need of mobile medical records. Moreover, it has been reported that 92% of U.S. pets will encounter an emergency situation throughout their lifetime. A travel industry association has reported over a 3-year study concluded in 2009 that 29 million pet owners traveled with their pets more than fifty miles from home. As pets grow more and more into the family dynamic, the number of traveling pets will increase. Consequently, more pets are traveling away from their veterinarian who possesses the medical history of the pet. This trend also carries over to a nationwide need for mobile medical records as a growing number of pet owners are starting to travel with their pets away from home. If a pet emergency situation develops during travel or during any situation where the pet is separated from his or her primary veterinarian, conventional record storage may not provide instant access to an accurate up-to-date copy of the pet's medical record. If an emergency situation develops during travel, current methodologies may not accurately, quickly, and/or efficiently provide the animal's medical history. These lack of medical records during an emergency add anxiety for both the pet owner and the emergency veterinarian.

More particularly, when an animal is injured or has some other medical emergency, proper medical attention may be delayed until the medical records of the animal are obtained from the veterinarian, or medical treatment may have to be provided absent the medical records. Furthermore, when a lost or injured animal is found, the animal rescue team and the veterinarian have no way of knowing the animal's history or existing condition and how to find the owner. Even if there is no question about how to treat the animal, preferences or desires of the owner are not known. The owner might want to save the animal at all costs no matter how badly injured the animal is, or the owner may wish to euthanize the animal if it is badly injured.

Some existing products may use an electronic profile coupled to a pet collar that may contain personal and pet medical information. For these conventional products, however, the pet owner must manually upload the medical information. This information can be a subjective summary of a pet's medical history through the owner's perspective. Since typical products compile medical information manually and/or by the pet owner, the accuracy of the medical information may be lacking.

For pet owners and/or veterinarians, a need exists for an animal data management system. Still further, a need exists for a video or imaging platform to access and/or transmit information relating to pets. Moreover, a need exists to enhance and expand the veterinarian's ability to perform diagnostics outside of the exam room. Further, a need exists for non-primary veterinarians such as emergency veterinarians to have efficient, correct, and convenient access to medical records.

### BRIEF SUMMARY

In one aspect, a computer implemented method for managing animal information between a remote server and an animal device is provided. The method includes storing the animal information on an animal database of the remote server; receiving, by the remote server, an authentication request of an identity parameter that is associated with the animal device; authenticating, by the remote server, the authentication request; and transmitting, by the remote server, the animal information from the animal database to a computing device.

In another aspect, a computer device for managing animal information is provided. The computer device includes a memory device configured to store the animal information. An interface device is coupled to the memory device and configured to receive input instructions. A processor is coupled to the memory device and the interface device, wherein the processor is programmed to: receive an authentication request of an identity parameter that is associated with an animal device; authenticate the authentication request; and transmit the animal information from the memory to a computing device.

In a further aspect, one or more non-transitory computer-readable media having computer-executable instructions embodied thereon for managing animal information using a computer device having a memory and a processor is provided. When executed by the processor, the computer-executable instructions cause the processor to: receive an authentication request of an identity parameter that is associated with an animal device; authenticate the authentication request; and transmit the animal information from the memory to a computing device.

### DRAWINGS

These and other features, aspects, and advantages will become better understood when the following detailed description is read with reference to the accompanying drawings in which like characters represent like parts throughout the drawings, wherein:

FIG. 1 is a schematic view of an exemplary animal data management system;

FIG. 2 is a schematic view of an exemplar computing device of the animal data management system shown in FIG. 1;

FIG. 3 is a flowchart illustrating an exemplary method of managing animal information; and

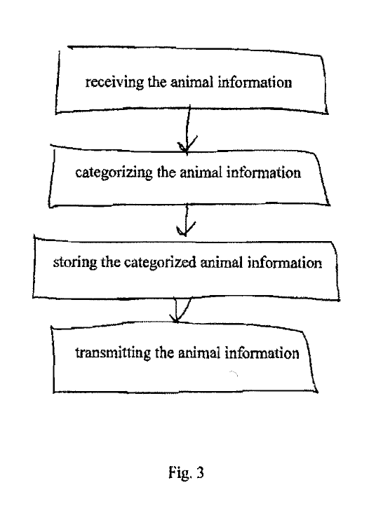

FIG. 4 is a block diagram of a plurality of modules of the system.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The embodiments described herein relate to systems and methods of providing a universal, integrated database for pet owners, veterinarians, and animal health facilities to provide real time access to a pet's medical history. More particularly, the embodiments described herein provide streamlined video and image messaging to facilitate a new and effective medium for sustained communication between veterinarians and pet owners to facilitate faster and more effective diagnostics. Moreover, the embodiments described herein facilitate software extraction for a pet's medical history such as, but not limited to, underlying disease conditions, allergies, drug history, surgery history, weight, and owner contact information onto a database accessible by a veterinarian and/or pet owner at any time. Although the embodiments described herein describe medical records relating to pets and associated pet owners and veterinarians, the embodiments can be directed to human patients and associated physicians. It should be understood that the embodiments described herein include a variety of medical records and patients, and further understood that the descriptions and figures that utilize animal/pet/veterinarian descriptions are exemplary only. The embodiments described herein are configured to be complaint with laws such as, but not limited to, the Health Insurance Portability and Accountability Act (HIPAA). The terms “animal”, “patient”, “human patient” can be used interchangeably. Moreover, the terms “veterinarian” and “physician” can be used interchangeably. The terms “animal records or animal database” can be used interchangeably with “human patient records or human patient database”.

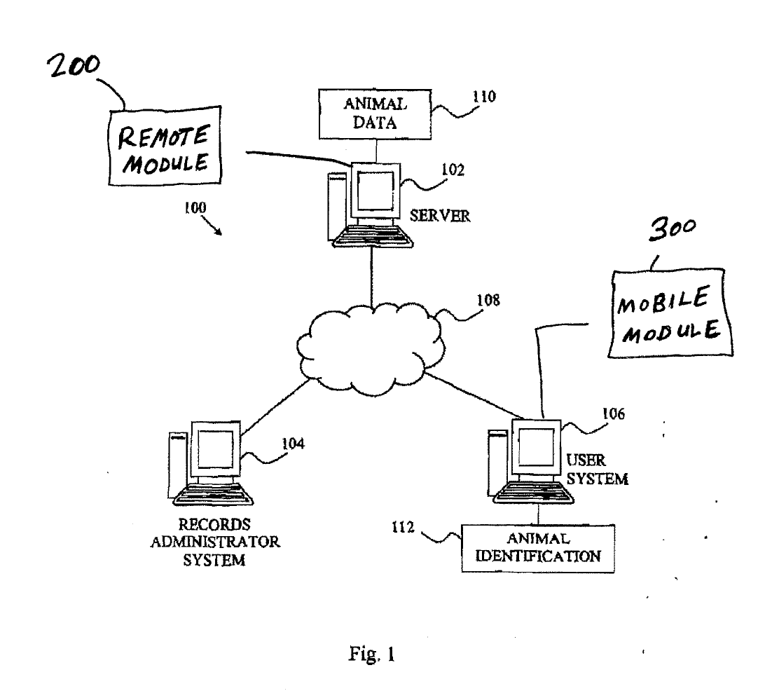

FIG. 1 is a schematic block diagram of an exemplary animal data management system 100. The system 100 is configured to facilitate accurate, concise, and convenient means of transporting a portion of a pet's medical records wherever the pet travels. The system 100 includes a pet device such as, for example only, a tag that can be placed onto a pet collar, wherein the tag may include a unique QR-like code that can be scanned to quickly access a corresponding pet profile, which is complete with owner contact information, primary veterinarian contact information, and emergency medical records. The system 100 includes programs to instruct extraction tools that are specific to electronic medical record systems used in veterinary hospitals. The extraction devices will pull a copy of pertinent medical data from a pet's legal medical record and display that extracted information onto a personalized pet profile within a secure database. With a QR-like code scanner and/or Internet access, a veterinarian can immediately access the health information database. Quick access is configured to facilitate identifying the pet's underlying health conditions, drug history, allergy history, surgery history, weight history, past blood work reports, histopathology reports, radiology reports, etc. in order to make the best medical decisions in an emergency. Even with pet emergencies that occur under the care of a pet sitter, boarding facility, grooming facility, or lost and found situation where the owner is not available, the system 100 facilitates that the pet's medical records can be accessed by a veterinarian. Also, if the tag is missing, a veterinarian can still gain access to the pet's records through inputting the pet's microchip number that is synced with the database of the system 100.

The system 100 is configured to provide a streamlined way to share pertinent medical information in a timely manner when it is needed the most. Moreover, the system 100 is configured to provide a pet owner to extract a copy of their pet's legal medical record to be securely stored on the system's database and instantly made available to the professional veterinary personnel helping in an emergency. The system 100 is configured to facilitate a regional 24/7 emergency veterinary hospital link of its referring hospital network onto the network. The system 100 is configured to unite a plurality of referring hospitals and thousands of patients under one emergency record service and providing access to a 24/7 emergency hospital in their region that will have the tools to provide for the patient. Moreover, the system is configured to allow input of medical records from specialty hospitals back to the referring hospital, allow clients to receive alerts about regional health threats in the area, regional lost pet alerts, pet medication and veterinary appointment reminders, integration with pet insurance claim submissions, and/or radiograph access between hospitals.

Animal data management system 100 is configured to provide quick and convenient access to animal data 110, while protecting the privacy of animal data 110 from unauthorized access. System 100 includes a server 102, a records administrator computing system 104, and a user computing device 106. In some embodiments, communication occurs across network 108 such as, for example, the Internet. Server 102 includes animal data 110. An animal identification device 112 is coupled to an animal (no shown). In the exemplary embodiment, the animal identification device 112 includes a microchip coupled to an animal collar (not shown). Alternatively, the animal identification device 112 may include a microchip embedded within the animal. Still further, the animal identification device 112 may include, but is not limited to, a Quick read (“QR”) code, a biometric reader (such as retinal scanning), a radio-frequency identification (RFID) tag detector, an image matching device, an interface for entering identification number from e.g. dog tag or earmark, a pet identification card reader, a DNA reader, and other devices for identifying an animal.

In the exemplary embodiment, the animal data 110 includes information relating to a particular animal. Examples of animal data include medical history data including, but not limited to, veterinarian notes, electronic medical records, immunization records, surgical history, medication records, medical treatment records, and identification of medical allergies, genealogy, owner information, owner's instructions in case of acute illness or injury (for example, treat or put to sleep, who to contact if owner is unavailable), insurance information, and other data relating to the animal. In some embodiments, the animal data 110 is not considered or treated as confidential. However, in other embodiments, measures are taken as confidential to safeguard the animal data 110 against unauthorized or improper use. For example, in some embodiments, communication of animal data 110 is performed in accordance with a secure data communication protocol, such as Secure Sockets Layer (SSL). Password protection is used in some embodiments. Other embodiments include other security features.

In an embodiment, animal data 110 includes multiple sections, including photo section, general info section, medical info section, and owner info section. Some embodiments include additional sections such as other wishes section, emergency contact information section, primary veterinarian section, health insurance section, and detailed status section. Photo section includes a photograph and/or a video image of the animal, if available. General info section displays general information about the animal. Examples of general information include name, ID number, gender, date of birth, weight, breed and genealogy. Medical info section includes information regarding medical conditions of the animal. Examples of medical conditions that are displayed in medical info section include different disorders, allergies, information about immunizations, diabetes, and any other medical info of interest such as current medication. In an embodiment, medical information is associated with a YES or NO field that indicates whether or not the animal currently has or previously has had the condition, and includes a note field where further details regarding the condition are displayed. Owner information section includes information such as, but not limited to, name, address, home phone number, work phone number, cell phone number, mail address and, if the owner has a location-transmitting device, such as a GPS-enabled smartphone, and the owner's present location.

In the exemplary embodiment, server 102 is configured to store animal data 110 in a memory of server 102. In other embodiments, animal data 110 is stored remotely from server 102, but is accessible to server 102, such as across network 108 or another network. In some embodiments, the animal data 110 is stored in a database or other data record. Server 102 is also configured to store pet owner information.

The user computing device 106 is a computing system typically operated by veterinarians, animal health clinic, animal rescue, animal breeders (such as kennels), animal shelters, emergency responders, emergency veterinarians and animal owners. In the exemplary embodiment, the user computing device 106 includes a stationary device, such as a computer system at the owner's home or at the animal health clinic. Alternatively, the user computing device 106 includes a mobile device, such as a laptop computer, cell phone, personal digital assistant, or other computing systems used by e.g. animal rescue teams, emergency veterinarians, and the owner. User computing device 106 may include any configuration to enable system to function as described herein. In some embodiments, user computing device 106 is configured to communicate data across network 108, such as to access animal data 110.

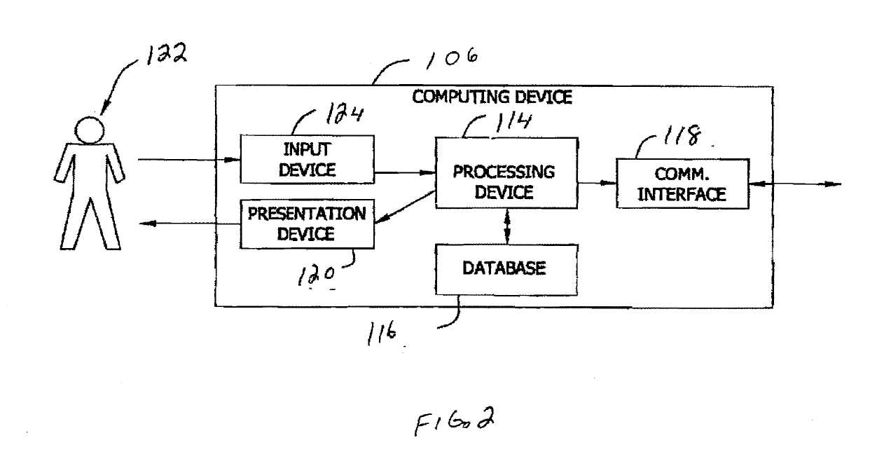

FIG. 2 illustrates an exemplary computing device 106. The computing device 106 includes a processing device 114 and a database 116 coupled to processing device 114. Processing device 114 may include any processing unit, such as, without limitation, a central processing unit (CPU), an integrated circuit (IC), an application specific integrated circuit (ASIC), a microcomputer, a microcontroller, a programmable logic device (PLD), and/or any other programmable circuit. A processor may include multiple processing units (e.g., in a multi-core configuration).

Database 116 is any device allowing information, such as executable instructions for processing device 114 and/or other data, to be stored and retrieved. The database 116 may include, without limitation, one or more random access memory (RAM) devices, read only memory (ROM) devices, hard drive devices, flash memories, optical devices, and/or other computer-readable media. Stored in the database 116 are, for example, computer-readable instructions for generating one or more profiles and/or probabilities of failure. In addition, or alternatively, database 116 may be configured to store animal data 110 transmitted from one or more record administrative computing systems 104 and user computing devices 106.

Computing device 106 includes a communication interface 118 that allows processing device 114 to communicate with network 108 and/or other computing devices 106 in communication with network 108. Additionally, a removable computer-readable media, such as a flash drive, CD-Rom, etc., may communicate with processing device 114 directly or via communication interface 118.

In some embodiments, computing device 106 includes at least one presentation device 120 for presenting information to user 122. The presentation device 120 is any component capable of conveying information to user 122. The presentation device 120 may include, without limitation, a display device (e.g., a liquid crystal display (LCD), an organic light emitting diode (OLED) display, or “electronic ink” display) and/or an audio output device (e.g., a speaker or headphones).

In some embodiments, the computing device 106 includes an input device 124 for receiving input from user 122. The input device 124 may include, for example, a keyboard, a pointing device, a mouse, a touch sensitive panel (e.g., a touch pad or a touch screen), and/or other suitable input devices for receiving one or more inputs from user 122. A single component, such as a touch screen, may function as both an output device of presentation device 120 and input device 124.

In some embodiments, server 102 includes separate interface modules for communicating with particular groups of users. For example, server 102 includes an administrative system interface for communicating with an administrator (such as through records administrator system 104), and a user system interface for communicating with user 122 (such as through user computing device 106). Server 102 may include separate interfaces for different groups of users, such as to provide different access rights to each group. For example, an animal owner using user computing device 106 is typically limited to accessing his or her own animal data 110, while a veterinarian using a user computing system such as system 106 will typically have access to the animal data of more than one animal. In some embodiments, system interfaces are custom software applications that control access rights and define particular Web pages to be displayed to the associated group. In some embodiments, system interfaces also define one or more communication protocols and operate to communicate data according to the protocols. For example, in some embodiments some or all communication between server 102 and one or more groups of users 122 occurs through one of the system interfaces rather than through network 108. In this way, data is communicated between the user system and server 102 according to a customized or other communication protocol.

In the exemplary embodiment, system 100 includes at least one of: 1) a software extraction tool; 2) a robust, secured database; 3) a unique, quick response (“QR”) like code placed on a tag on a pet collar; and 4) an interactive and responsive website available as a mobile and computer platform. More particularly, data extraction software is configured to retrieve pertinent pet health information and “lost and found” information from hospital medical records to a secure database to be accessed by any veterinarian for emergency treatment using retrieval technology such as scanning code technology. Moreover, a video and image messaging service on the mobile device is configured to allow communication between pet owners and veterinary health organizations to facilitate better communication, diagnostics, and patient satisfaction. The system further is configured to allow pet owners to receive alerts about health threats in the area, as well as have access to trusted medical information, sync appointments, vaccine reminders, and medication reminders to their calendar automatically.

In the exemplary embodiment, the software extraction tool is a product downloaded onto veterinary hospital servers, similar to a pet portal extraction tool. In the exemplary embodiment, the extraction tool is compatible with the major versions of pet electronic medical records and is configured to retrieve information of each pet's medical history onto the database. In an embodiment, medical information includes, but is not limited to: 1) body weight; 2) surgery history; 3) allergy history; 4) drug history; 5) vaccine history; 6) important underlying diseases (comorbidities); 7) microchip number; 8) pet's name, age, breed, markings, photo; and 9) owner information (name, address, phone). The medical information which is critical in pet emergency situations is provided to the veterinarian when treating an emergency. The extraction tool is configured to update this information onto the database on a regular interval, for example every night, ensuring that the health information is as up-to-date.

As this information is pulled onto the secure database, the animal profile is created containing an up-to-date medical history snap-shot. The database may be accessed via a code attached to a simple tag on the pet's collar. The veterinarian can scan this code with a smart phone application or manually type in the pet's microchip number onto the computer database and have access to the pet's profile at any time. Another feature that is available on the pet's profile is the ability to access images and videos sent between the veterinarian and pet owner. The system is configured to allow pet owners and veterinarians to connect and/or communicate on a mobile platform that allows both parties to exchange images and videos of pets. The service can be dedicated to just health based communication or can be integrated into use on social media sites to share pet specific images on multiple venues. All videos and pictures exchanged between the client and veterinarian can be saved onto the database creating a visual profile of a pet's health.

In the exemplary embodiment, the system 100 is configured to provide a platform for the pet owner such as, but not limited to:

Ability to sync with microchip for ease of access to pet records at any time;

Pertinent pet health records available on the system;
Ability for pet owner to see pet allergies, weight, age, sex, general health conditions diagnosed by veterinarian;
Links to websites (approved by veterinarians) that can show the pet owner what this diagnosed disease/condition is in case they want to “learn more”; and
Ability to scan barcodes on pet food products that the pet owner is feeding to the pet and to store the brand on the phone under health history so the veterinarian knows what the animal is eating.

Pet owner can send a video voicemail message to veterinarian.
Pet owner can take a video/picture of pet through the system.
The system is configured to inquire about the identity of the pet in the video/picture. Then the system is configured to inquire if the situation is a medical emergency, non-emergency, or non-medical situation.
If the situation is categorized as emergency, then the related picture/video is sent to the veterinarian. The system is configured to automatically dial the veterinary clinic.
If categorized as medically related, an option will pop-up asking if the pet owner would like to make an appointment and if “yes”, the system is configured to call the veterinary clinic directly.
If categorized as a non-medical situation and the pet owner, for example, simply wanted to show the veterinarian that the puppies from the recent C-section are growing big and strong, that video can be screened such that the medically related multimedia can be addressed first.
For example, if a dog has a seizure, the pet owner can take a video and send it to the veterinary clinic where the video will connect with the pet's history file. The veterinarian can then review the video and make a diagnosis while also having a better idea of treatment when the animal comes into the veterinary clinic.

Veterinary hospital phone number and address are available.

Health reminders for the pet owner (vaccinations, monthly flea/tick and heart worm preventative, medication administration).

Veterinary appointment reminders.
Vaccinations, surgery rechecks, sync to a phone calendar and remind the pet owners of appointments at their local veterinary clinic.

Area warnings for local disease outbreaks, food recalls, reminders surrounding specific holiday health risks.

Pet insurance compatibility and ability to submit claims efficiently or sign up for pet insurance if the pet owner does not currently have a policy.
When owners register for the system after obtaining the microchip, the pet owner can be asked if they have pet insurance and can pick a package if they are currently enrolled in a program. The system is configured to electronically submit insurance claim forms from the system to facilitate improved accuracy and turnaround for pet insurance. The system is configured to allow pet insurance companies to ask the pet owner if they would like to sign up for an insurance package and provide recommendations.

Pet Poison Control hotline.
Potentially negotiate a discounted fee with the pet poison hotline for pet owners when they call via the system.

Access to online pharmacy if the veterinary clinic distributes products online. Alternatively, the recommended products are offered in-house by the system and at the vet clinic, to reduce or eliminate outsourcing.

Social Media.
Pet social media that allows pet owners to share videos/pictures of their pets with a greater network around the world. The system is configured to increase the number of times the pet owner will visit the system each day/week, to facilitate increased awareness to their pet health recommendations/risks:
   Can share special moments in their pet's lives: birthday parties, hunt trials, dog shows, medical success stories from their vet clinic, etc.;
Animal meme generator; and
   Animal of the day picture available.

In the exemplary embodiment, the system 100 is configured to provide, for the pet owner, real time access to pet information while providing convenient reminders and connection with the veterinarian. Moreover, the system 100 is configured to provide photo and video capturing and sharing in multiple media outlets to provide a social media network for the pet owner and the veterinarian. The system 100 is configured to integrate with a plurality of micro-chip manufacturers. When integrated with the micro-chip, the system 100 is configured to be accessible by the veterinarian at any time to facilitate proper, safe, and efficient treatment protocol. Still further, the system 100 is configured to integrate with a plurality of pet insurance carriers to facilitate convenient and efficient pet insurance application and claim submissions.

In the exemplary embodiment, the system 100 is configured to provide a platform for the veterinarian such as, but not limited to:

Pet health reminders for the veterinarian.
When an animal walks through the door and the microchip is scanned by the office staff, alerts can pop up to remind the veterinarians and staff about vaccinations being overdue, pertinent medical history, previous diagnoses and other flagged information.

Ability for veterinarian to recommend specific supplements/foods/products.
Can use scanner capabilities to scan the products available on the shelf in the clinic and it will automatically sync to the application's health product recommendations given to the pet owner to facilitate health product recommendations presented to the pet owner.

Ability to receive video voicemails to substitute/supplement phone voicemails to facilitate more accurate information and a quicker process for both the pet owner and the veterinarian.
Ability for veterinary staff to send videos/pictures to the pet owner regarding medical recovery updates as a way to supplement follow-up calls with the pet owner regarding patient progress.

In the exemplary embodiment, the system 100 is configured to provide pet medical information to veterinarians, specialists and emergency veterinarians when the animal is brought to a medical facility which can include a 24/7 emergency medical facility. The system 100 is configured to provide access to pet owners via application notifications and alerts for appointments, health recommendations, and health threats. Moreover, the system 100 is configured to provide access to the clinic's phone number to the pet owner. Still further, the system 100 is configured to receive video voicemails/picture images from the pet owner while sending video/picture updates to the pet owner. The system 100 is configured to support the veterinarian's medical and nutritional recommendations via providing access to the veterinarian's website, on-line pharmacy, alerts and notifications to facilitate minimizing or eliminating outsourcing and maximizing hospital exposure for sale of products and services.

In the exemplary embodiment for the pet industry, the system 100 is configured to provide access to the pet owning community for marketing and brand recognition. Moreover, the system 100 is configured to provide a support system for veterinarian partners. The system 100 is configured to facilitate increasing medication and/or food compliance. Still further, the system 100 is configured to conveniently and efficiently offer pet insurance policies. The system 100 is configured to facilitate increasing revenues for microchip companies.

During an exemplary operation, animal data 110 is entered. For example, the owner's name and the animal's sex, weight, birth date, medical history data, genealogy etc. are stored in a database record associated with the animal. For example, a user accesses the animal data on server 102 through user computing device 106 (shown in FIG. 1). The user is allowed to edit and update some or all of the animal data 110 as needed.

In the exemplary embodiment, a graphical user interface begins with login interface. In some embodiments, login interface is defined by server 102 and is displayed by a computing system, such as user computing device 106 (or another computing system including records administrator system 104), all shown in FIG. 1. Login interface prompts a user such as, for example only, the pet owner to enter the pet owner name and a password in order to proceed. A username prompt prompts the user for the pet owner name and a password prompt prompts the user for a password.

After the username and password have been entered by the pet owner, the pet owner then selects a login button. In some embodiments, upon selection of login button the username and password are communicated to a server for evaluation. If the username and password match the pet owner name and password for an active user account, the pet owner is allowed to gain access into the system.

A user, such as for example only a veterinarian, working in the animal health clinic or animal hospital or emergency animal hospital, uses the animal data to get to the animal's health record in operation and also to see the pet owner's statement or directive regarding treatment of the animal. In some embodiments, the veterinarian can access the animal data through a wireless communication device using the identifier and find information about e.g. owner, medical history, immunizations, and how and if treating the animal. Examples of wireless communication devices include a radio transceiver, cell phone, wireless modem, satellite communication system, infrared communication system, and other communication systems that communicate using electromagnetic waves. An electronic animal record associated with an identifier of the animal, such as a biometric identifier, is helpful to verify that the animal has immunizations, especially rabies shots. The owner may also store an advanced directive or living will for the animal. Such advanced directives might be the owners wish to donate organs of a diseased animal to, for example, universities for study.

In the exemplary embodiment, the system 100 is configured to process billing, for example, medical expenses incurred. In some embodiments, the veterinarian provides invoices such as by sending the invoices to server 102 (shown in FIG. 1). In some embodiments, invoices are then electronically delivered to the pet owner such as through user computing device 106 (shown in FIG. 1). In some embodiments, records of invoices and associated payments (by the pet owner) are stored with the animal's records.

In the exemplary embodiment, the system 100 is configured to process medical transcription or medical codes within electronic medical record software. For example, the veterinarian records dictation of medical care or diagnosis that was performed, such as in a digital audio file. The digital audio file is then transferred to server 102. In some embodiments, the server 102 transfers the file to a medical transcription service that converts the dictation into a medical record. The medical record is then transferred back to the server 102 and stored in the animal's records.

Moreover, in the exemplary embodiment, the system 100 is configured to process special care instruction such as the pet owner's desires for care upon the occurrence of a health event. In an embodiment, special care instructions include a list of possible special care instructions associated with a YES or a NO. A YES indicates that the pet owner does want the veterinarian to follow the associated special care instruction and NO indicates that the pet owner does not want the veterinarian to follow the associated special care instruction. Special care instructions may include instructions such as, for example only: do not x-ray, medication for pain only, medication/treatment/hospitalization as needed, and euthanize if badly injured.

In the embodiments described herein, a visit to the exam room no longer becomes the only visible assessment of the animal by the veterinarian. The system 100 is configured to allow the veterinarian to make observations based upon the video and image exchanges and determine that a situation has improved or progressed and identify key differentials before the pet is seen in-person. The ability to extend observation of a pet's health outside the exam room can lead to significantly decreased time spent in the exam room as diagnostics become more efficient and accurate. Also, increased communication between the veterinarian and the pet owner through the system builds loyalty and trust. Moreover, pet owner engagement facilitates creating a more loyal client base providing a benefit to veterinary hospitals to fill appointment books. The video and imaging technology of the system 100 facilitates bringing the veterinarian back into the pet owner spotlight with regards to convenient and trusted access to expert opinions for the pet's health.

In an embodiment, if the pet owner opts to share, within the industry, information such as, for example only, their pet's age, location, breed, and activity level, pet food companies and other industry leaders can make even more individualized marketing campaigns for their products. The system 100 is configured to allow pet insurance companies to offer pet insurance packages upon registration of the application by those in the pet industry. Including a social media feature to the system 100 facilitates increasing the frequency that a pet owner, for example, utilizes the system 100 to facilitate secondarily increasing exposure to health reminders and convenient access to veterinarians.

In the exemplary embodiment, the system 100 provides medical personnel with secure access to electronic health information anywhere (web/Internet) including, but not limited to: personal computers, iPhones, Blackberries, Android phones, personal mobile devices and any Internet or communication network accessible devices worldwide. The system 100 includes one or more servers 102 which communicate with the distributed computer network 108 via communication channels, whether wired or wireless, as is well known to those of ordinary skill in the pertinent art. In the exemplary embodiment, the distributed computer network 108 is the Internet or a private intranet, and can be “cloud” based. For simplicity, the following description refers to a single server 102 although several that function as a unit can be used. Server 102 is configured to host multiple Web sites and houses multiple databases necessary for the proper operation of the electronic health record system 100.

The server 102 is any of a number of servers that are intended to be operably connected to the network 108 so as to operably link to a plurality of computing device 106 via the distributed computer network 108. Distributed computer network 108 may include any number of network systems. For example, distributed computer network 108 may be a combination of local area networks (LAN), wide area networks (WAN), or, as is well known, the Internet. For the Internet, the preferred method of accessing information is the World Wide Web.

The computing device 106 includes devices such as desktop computers, laptop computers, personal digital assistants, tablets, cellular telephones and the like. The computing device 106 allows users such as, but not limited to, to access information on the server 102. The computing device 106 has displays and an input device(s) 124 (as would the server 102). It should be recognized that the signals being outputted from the computer can originate from any of a number of devices including PCI or AGP video boards or cards mounted within the housing of the computing device 106 that are operably coupled to the microprocessors and the displays of the computing device 106.

Computing device 106 typically provides to the medical personnel access to the system 100. A plurality of users typically can share the same computing device 106 and cookie technology can be utilized to facilitate access to the system 100, wherein the plurality of users can utilize the system 100 simultaneously. The computing device 106 are also preferably equipped with input devices 124 which can be used to provide input signals for control of applications programs and other programs such as the operating system being executed on the computing device 106. Any device is acceptable that generates the control signals or commands for implementing and interacting with the electronic health record system and the applications program embodying such methodology can be implemented in the form of discrete commands via a keyboard.

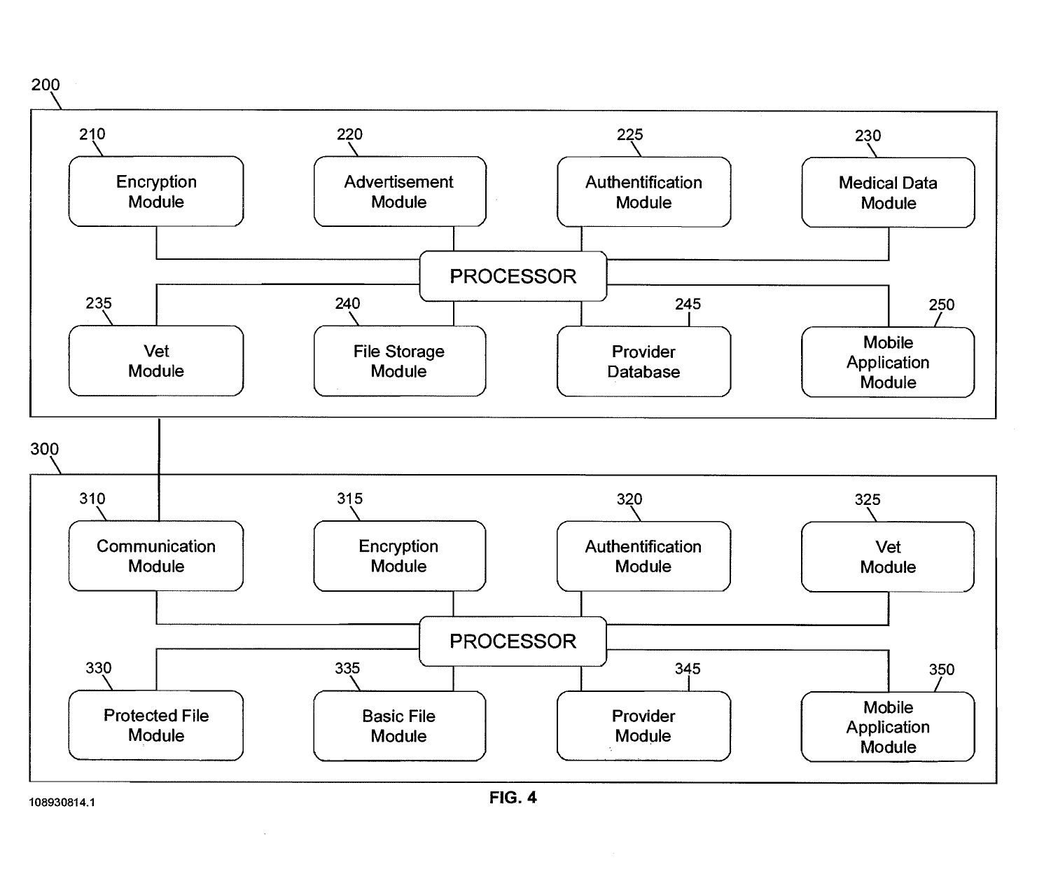

FIG. 4 is a block diagram representation of a remote medical information storage device 200 that is coupled to server 102. Remote medical information storage device 200 includes at least one of animal data 110, an encryption module 210, an advertisement module 220, an authentication module 225, a medical data module 230, a veterinarian module 235, a file storage module 240, a provider database 245, a mobile app module 250. Each module 205-250 of remote medical information storage device 200 is connected to server 102.

Remote medical information storage device 200 may be a server or any number of servers that store medical information remotely. Animal data 110 may be a single database or any number of databases configured to store user data including, but not limited to, owner and/or pet names, ID numbers, passwords, and medical and non-medical information relating to animals, pets, and/or human patients. Animal data 110 may reside on a single remote medical information storage device 200, across multiple remote medical information storage devices 200, or even multiple remote computers (e.g., for instance, the password database may reside on a company server and the remaining modules on a health provider's server).

Encryption module 210 represents any module related to data encryption. For instance, it may be beneficial to encrypt data as it is transferred among the server 102, the computing devices 106, and the network 108. Encryption may also be beneficial for data stored on personal medical information or in database 110. For example, unencrypted data may be accessed and stolen or read, while encrypting data may serve as an additional layer of protection to avoid data theft. Encryption module 210 may be connected to server 102. Data may be transferred between modules, such as between animal database 110 and encryption module 210, via server 102.

Advertisement module 220 represents a module configured to enable product advertisements and recommendations. Advertisement module 220 is connected to processor 102 and is therefore in communication with the other modules of remote medical information storage device 200. For instance, advertisement module 220 may exchange data with animal database 110 in order to assess a given pet's relevant medical needs and to propose relevant advertisements and recommendations. In one example, an owner of a diabetic pet may receive an advertisement related to a new insulin test. In yet another embodiment, users may receive advertisements or recommendations directly from their health care providers. For instance, a veterinarian may desire to remind a pet owner to seek a refill prescription after a predetermined period of time has elapsed, and therefore, advertisement module 220 may be configured to facilitate such reminders with respective advertisement placement.

Authentication module 225 represents a module configured to authenticate animal database 110. For instance, when animal database 110 is accessed by computing device 106, remote medical information storage device 200 may verify that the animal database 110 has not been lost, or compromised. The authentication module 225 may authenticate using any suitable authentications means. For instance, an authentication script or routine in any possible form may be employed and is contemplated by the present disclosure. As used herein, authentication routine refers to any possible form of authentication used to verify the status of animal database 110 or personal human patient information. In one embodiment, if it is determined that the personal medical information storage device 200 has been reported lost, stolen or compromised, authentication module 225 may transmit a command to wipe or erase the data stored on the medical information storage device 200. Otherwise, authentication module 225 may grant access to the information contained on medical information storage device 200.

Medical data module 230 represents a module configured to store medical data. In some cases, a human patient's medical data or animal data may be stored in user database 205; however, in other cases it may be desirable to store medical data in a dedicated medical data module 230. Medical data module 230 may also be used to store provider information such as provider-specific medical forms. Medical data module 230 is connected to processor 102 in order to enable communication between modules. In one embodiment, medical information may be transferred from input 124 to medical data module 230 via processor 102.

Veterinarian module 235 represents a module configured to store veterinarian notes. Module 235 can also be configured for physicians for physician's notes. For example, a veterinarian may draft and store a note regarding, for instance, a diagnosis to facilitate the exchange of information with other veterinarians. In one embodiment, veterinarian module 235 may be configured such that once a veterinarian saves a note, it may not be edited. Alternatively, the veterinarian note can be edited. Veterinarian module 235 may be configured to encrypt and otherwise store veterinarians with protection. Veterinarian module 235 may protect sensitive information by any suitable means. For instance, in one example, veterinarian module 235 may comprise UNIX-like permissions and may only grant read permissions. Alternatively, veterinarian module 235 may also permit the deletion, but deletion only, of veterinarian's notes. In another example, veterinarian module 235 may comprise Microsoft or IBM DOS variant attributes to restrict access to read-only or delete-only access.

File storage module 240 represents a module configured to store user files such as, for example, images, and PDFs, among other things. For instance, a user may desire to store, copies of vaccination records, or non-medical information such as, but not limited to, copies of insurance policies, sickness history, owner information and injuries.

Provider database module 245 represents a module related to provider-specific information. In one embodiment, a provider may pre-load predetermined information and files such as, for example, specific forms and pamphlets. Provider database module 245 may also comprise provider layers configured to apply a standardized layer specific to a given provider. Provider database module 245 may communicate with other modules of remote medical information storage device 200.

Mobile app module 250 represents a module configured to present the different modules and information stored in remote medical information storage device 200 in a format for small screens such as for smartphones. For instance, remote medical information storage device 200 may determine that computing device 106 has made a request for information, may determine that computing device 106 is a smartphone, and may direct all communications through mobile app module 250 to ensure that the data appears as desired.

FIG. 4 also shows a block diagram representation of a mobile medical information storage device 300. In the exemplary embodiment, the computing device 106 includes a mobile phone. The storage module 300 is coupled to at least computing device 106. Mobile medical information storage device 300 may comprise a plurality of modules including, input devices 124, a communications module 310, an encryption module 315, an authentication module 320, a veterinarian's module 325, a protected files module 330, a basic files module 335, a provider module 345, and a mobile module 350. Many of the modules have been discussed above in relation to remote medical information storage device 200. The modules may be stored on a data storage unit, or memory unit, of mobile medical information storage device 300. For instance, in one embodiment, mobile medical information storage device 300 comprises an electronic, magnetic, or resistive memory device.

Communications module 310 represents a module configured to enable the communication of data from mobile medical information storage device 300 and remote medical information storage device 200. In one embodiment, communications module 310 may facilitate the communication between computing device 106 and server 102. As used herein, a communication connection is any connection configured to enable the transmission and reception of data between a mobile medical information storage device 300 and a remote medical information storage device 200, and may be established by communications module 310. Protected files module 330 represents a module configured to store and facilitate access to files that have been identified as “protected” by the user. For instance, in one embodiment sensitive personal information, such as social security numbers, medical and medication histories, birth certificates, among other things, may be specially identified as “protected” and may only be accessed by password. On the other hand, in this embodiment, non-protected files such as vaccination records or any other files that the user wishes to be accessed without having to enter a password may be stored in a basic files module 335.

Mobile app module 350 represents a module configured to present the different modules and information stored in mobile medical information storage device 300 in a format for small screens such as for smartphones. For instance, mobile medical information storage device 300 may determine that computing device 106 has made a request for information, may determine that computing device 106 is a smartphone, and may direct all communications through mobile app module 350 to ensure that the data appears as desired.

In operation, the different modules of mobile medical information storage device 300 may work in concert with medical information storage device 200, and with corresponding modules thereof, in order to facilitate the exchange of medical information, to ensure that medical information is up-to-date, and to protect the medical information against theft and loss. In one example, mobile medical information storage device 300 may be connected to computing device 106, following which, the authentication module 320 operates to communicate with the animal database 110 and processor 102 of remote medical information storage device 200. Once mobile medical information storage device 300 receives a confirmation of authentication, then computing device 106 may display information from at least one of the animal database 110, the basic files 335, from the veterinarians 325, and protected files 330.

In an exemplary embodiment, mobile medical information storage device 300 includes a credit card-like IC chip (such as the EMV chips used in charge cards) and display a user name. Optionally, mobile medical information storage device 300 may also include a mini-USB connection, a user photo, a logo, and/or QR code.

In operation, mini-USB connection may enable connection with computing device 106. Additionally, the QR code may enable a person, such as an emergency responder, to scan the card and have immediate access to the animal data 110. In one embodiment, the inclusion of user photo facilitates a visual confirmation that the mobile medical information storage device 300 belongs to the pet. It is understood that mobile medical information storage device 300 (in any embodiment) may comprise other modules and/or functionality including, but not limited to, GPS, RFID, and NFC. For instance, in one embodiment, a GPS chip (not shown) may facilitate geospatial identification for authorization purposes. In another embodiment, the GPS chip may be configured to provide relevant information to facilitate the identification of relevant advertisements. Of course, a GPS chip may be configured to provide any number of relevant functionalities. In other embodiments, radio-based close proximity transmission features and functionality may also be included. For instance, mobile medical information storage device 300 may include RFID or NFC functionality in order to facilitate data transmission.

During an exemplary operation, the animal information is stored on the animal database 110 of the remote server 102. The emergency medical personnel or the emergency veterinarian scans the animal device with the computing device 106. The computing device 106 accesses an identity parameter such as a log-in code and sends an authentication request to the remote server 102 to gain access to the animal database 100. In one embodiment, the emergency veterinarian scans the QR code coupled to the animal device with a mobile phone to electronically access at least the identity parameter. In an embodiment, the mobile phone using the mobile module wireless sends the authentication request to the remote server 102. The remote server 102 the authentication request and associated identity parameter that is associated with the animal device. The remoter server 102 authenticates the authentication request and transmits from the remote server 102 the animal information from the animal database 110 to the computing device 106, for example, the emergency veterinarian's mobile phone. The computing device 106 can also electronically send to the remote server 102a geo spatial location of the animal device wherein the remote server 102 receives the geo spatial location of the animal device or computing device 106. The remote server 102 can transmit a location of an emergency facility to the computing device 106.

In the exemplary embodiment, the animal information includes at least one of a body weight, a surgery history, an allergy history, a drug history, a vaccine history, a disease, a microchip number, a pet's name, a pet's age, a pet's breed, a pet's markings, a pet's photo, a client information, and a video image. In operation, the animal information can be electronically and/or remotely updated within the animal database 110. Moreover, the animal information can be encrypted within the animal database 110.

In another operation, QR-like code is scanned by the emergency medical personnel or emergency veterinarian using computing device 106 to access pet profile stored on the animal database 110. This profile is complete with basic owner and veterinary contact information and basic information about the pet. More sensitive owner contact information and pet medical record information on the animal database 110 can be accessible through a password provided specifically to the emergency veterinary hospital(s). The medical records on the animal database 110 are in a read-only format for viewing by the emergency veterinarian. This medical profile can be edited by adjusting the actual pet medical record data stored on the server 102 which can be the primary veterinarian's electronic medical record software. A pet owner also has limited viewing access of the information on their pet profile. In an exemplary use, the owner will not be able to view the hospital extracted medical records nor edit the medical record data to ensure that a consistent and accurate record is made available to an emergency veterinarian at all times. If an owner would still like to add extra information to their pet profile that could be useful during an emergency, there will be several text fields available on the pet profile where the pet owner can add extra information relevant to the pet's medical history. During use, the system 100 unites a plurality of referring hospitals and thousands of patients under one emergency record service and giving them access to a trusted 24/7 emergency hospital in their region that will have the tools they need to provide for the patient.

The system 100 is configured for at least one of a: small animal (canine and feline) veterinary hospitals and canine and feline pet owners; equine veterinary industry, pet insurance companies, and pet product companies. Moreover, the system 100 is configured to provide a platform for communication between referring veterinarians, and specialty centers/emergency hospitals. Additionally, regional “Lost Pet Alerts” can be sent to other pet owners in surrounding zip codes. For a deceased pet, the system 100 is configured to receive an alert from the extraction tool and an automated email is sent to the owner expressing condolences. Within this email, the system 100 can alert the pet owner that a veterinarian would like to make a small donation to a charity of choice in memory of their pet that passed away. The system 100 can provide regional alerts for food recalls, infectious disease outbreaks. Still further, the system 100 is configured to send pet specific health and appointment reminders to pet owners to enhance consistency of pet health. The system 100 can link with Pet Poison control during pet emergencies. Moreover, other companies can use the system 100 to market and cater their products and services to customers.

A technical effect of the systems and methods described herein includes at least one of: (a) storing, managing, and transmitting information relating to animals; (b) generating, storing, and transmitting video and/or imaging data relating to animals; (c) enhancing and expanding a veterinarian's ability to perform diagnostics outside of an exam room, and (d) providing a universal, integrated database for pet owners, veterinarians, and animal health facilities to provide real time access to a pet's medical history.

In the specification and the claims, reference will be made to a number of terms, which shall be defined to have the following meanings. The singular forms “a”, “an”, and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein. Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

Processor is not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not limited to, a scanner. Furthermore, in the exemplary embodiment, additional output channels may include, but not be limited to, an operator interface monitor. The above examples are exemplary only, and thus are not intended to limit in any way the definition and/or meaning of the term processor.

Exemplary embodiments of an animal information system are described herein. The methods and systems are not limited to the specific embodiments described herein, but rather, components of systems and/or steps of the methods may be utilized independently and separately from other components and/or steps described herein. For example, the methods may also be used in combination with other manufacturing systems and methods, and are not limited to practice with only the systems and methods as described herein. Rather, the exemplary embodiment may be implemented and utilized in connection with many animal and/or human patient applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer implemented method for managing animal information between a remote server and an animal device, the method comprising:
storing the animal information on an animal database of the remote server;
receiving, by the remote server, an authentication request of an identity parameter that is associated with the animal device;
authenticating, by the remote server, the authentication request; and
transmitting, by the remote server, the animal information from the animal database to a computing device.

2. The computer implemented method of claim 1, further comprising electronically accessing the identity parameter from the animal device by the computing device.

3. The computer implemented method of claim 2, wherein electronically accessing the identity parameter comprises electronically scanning a quick response code coupled to the animal device.

4. The computer implemented method of claim 3, wherein the computing device comprises a mobile phone.

5. The computer implemented method of claim 1, wherein the animal information comprises at least one of a body weight, a surgery history, an allergy history, a drug history, a vaccine history, a disease, a microchip number, a pet's name, a pet's age, a pet's breed, a pet's markings, a pet's photo, and a client information.

6. The computer implemented method of claim 1, further comprising remotely updating the animal information stored in the animal database.

7. The computer implemented method of claim 1, further comprising encrypting the animal information stored in the animal database.

8. The computer implemented method of claim 1, wherein transmitting the animal information comprises transmitting a video image.

9. The computer implemented method of claim 1, further compromising receiving, by the remote server, a geo spatial location of the animal device that is transmitted by the computing device.

10. The computer implemented method of claim 1, further comprising transmitting, by the remote server, a location of an emergency facility to the computing device.

11. A computer device for managing animal information, the computer device comprising:
a memory device configured to store the animal information;
an interface device coupled to the memory device and configured to receive input instructions;
a processor coupled to the memory device and the interface device, the processor programmed to:
receive an authentication request of an identity parameter that is associated with an animal device;
authenticate the authentication request; and
transmit the animal information from the memory to a computing device.

12. The computer device of claim 11, further comprising electronically accessing the identity parameter from the animal device by the computing device.

13. The computer device of claim 12, wherein electronically accessing the identity parameter comprises electronically scanning a quick response code coupled to the animal device.

14. The computer device of claim 11, wherein the animal information comprises at least one of a body weight, a surgery history, an allergy history, a drug history, a vaccine history, a disease, a microchip number, a pet's name, a pet's age, a pet's breed, a pet's markings, a pet's photo, and a client information.

15. The computer device of claim 11, further comprising remotely updating the animal information stored in the memory.

16. The computer device of claim 11, further comprising encrypting the animal information stored in the memory.

17. The computer device of claim 11, wherein transmitting the animal information comprises transmitting a video image.

18. One or more non-transitory computer-readable media having computer-executable instructions embodied thereon for managing animal information using a computer device having a memory and a processor, wherein when executed by the processor, the computer-executable instructions cause the processor to:
receive an authentication request of an identity parameter that is associated with an animal device;
authenticate the authentication request; and
transmit the animal information from the memory to a computing device.

19. A computer implemented method for managing animal information, the method comprising:
receiving the animal information;
categorizing the animal information;
storing the categorized animal information; and
transmitting the animal information.

20. The computer implemented method of claim 1, wherein receiving the animal information comprises electronically scanning the animal information.
